(19) United States
(12) Patent Application Publication
(10) Pub. No.: US 2003/0043724 A1
(43) Pub. Date: Mar. 6, 2003

(54) Optical pickup apparatus having beam splitter on which hologram is formed and method of compensating for deviation between optical axes using the optical pickup apparatus

(76) Inventor: Bong-gi Kim, Seoul (KR)

Correspondence Address: STAAS & HALSEY LLP, 700 11TH STREET, NW, SUITE 500, WASHINGTON, DC, 20001, US

(21) Appl. No.: 10/076,075

(22) Filed: Feb. 15, 2002

(30) Foreign Application Priority Data
Aug. 30, 2001 (KR) 2001-52955

(51) Int. Cl. G11B 7/135

(52) U.S. Cl. 369/112.14; 369/112.15

(57) ABSTRACT

An optical pickup apparatus having a beam splitter on which a hologram is formed, and a method of compensating for a deviation between optical axes using the optical pickup apparatus . The optical pickup apparatus includes a first light source for generating a first light beam; a second light source for generating a second light beam whose optical axis is parallel to the optical axis of the first light beam, the second light source being disposed optically farther from a recording medium than the first light source; a photodetector; an objective lens; and a beam splitter disposed on an optical path between the objective lens and the photodetector, the beam splitter comprising a first surface for reflecting the first light beam and the second light beam toward the objective lens and simultaneously transmitting the first light beam and the second light beam, and a second surface on which a hologram is formed for compensating for a deviation between optical axes of the first and second light beams transmitted through the first surface. Since the difference between optical axes can be compensated for using a beam splitter on which a hologram is formed, the optical pickup apparatus can be easily manufactured and its performance can be improved.

### CROSS-REFERENCE TO RELATED APPLICATIONS

This application claims the benefit of Korean Patent Application No. 2001-52955 filed on Aug. 30, 2001, in the Korean Industrial Property Office, the disclosure of which is incorporated herein by reference.

### BACKGROUND OF THE INVENTION

1. Field of the Invention

The present invention relates to an optical pickup device and a method of compensating for a deviation between optical axes using the same, and more particularly, to an optical pickup apparatus to compensate for a deviation between optical axes of light traveling to a photodetector and a method of compensating for a deviation between optical axes using the optical pickup apparatus.

2. Description of the Related Art

Digital versatile disc (DVD) players are apparatuses to reproduce data recorded on DVDs but are usually manufactured to be compatible with both DVDs and conventional compact discs (CDs). Accordingly, many conventional optical pickup apparatuses include separate laser diodes as light sources for CDs and DVDs, respectively, in order to reproduce data from both CDs and DVDs. As a result, their structures are complicated, a large number of parts are used, and they are expensive to manufacture.

To decrease the number of parts used to manufacture optical pickup apparatuses, some conventional optical pickup apparatuses use a dual wavelength laser diode including both a laser diode for DVDs which emits light having a wavelength of 650 nm and a laser diode for CDs which emits light having a wavelength of 780 nm. However, since the two laser diodes are separated from each other by a distance of 110 μm, the optical axes of two light beams emitted from the two respective laser diodes deviate from each other.

In a conventional optical pickup apparatus, when a photodetector and other optical devices are arranged on the optical axis of one of the two light beams, the other light beam having a different optical axis does not form a focal point on the photodetector, so a normal optical signal cannot be detected.

FIG. 1 is a diagram of an example of a conventional optical pickup apparatus using a holographic optical element (HOE) in order to overcome the above problem. Referring to FIG. 1, a conventional optical pickup apparatus includes an HOE 20 to correct the optical axes of a first light beam 13a and a second light beam 15a which are emitted from a light source 11 and reflected from a recording medium 25 and which have different wavelengths. The HOE 20 is provided on an optical path between a beam splitter 19 and a photodetector 29. An objective lens 23, a collimating lens 21, the beam splitter 19, the HOE 20, and a concave lens 27 are sequentially arranged on an optical path between the recording medium 25 and the photodetector 29.

The first light beam 13a emitted from a first light source 13 or the second light beam 15a emitted from a second light source 15 is transmitted through a grating 17, reflected from a first surface of the beam splitter 19, sequentially transmitted through the collimating lens 21 and the objective lens 23, and focused on the recording medium 25. The first light beam 13a or second light beam 15a which is reflected from the recording medium 25 is sequentially transmitted through the objective lens 23, the collimating lens 21, and the beam splitter 19, and is incident on the HOE 20.

The conventional optical pickup apparatus compensates for a deviation between the optical axes by properly diffracting the first light beam 13a and the second light beam 15a using the HOE 20, thereby focusing the first light beam 13a and the second light beam 15a at a predetermined focal point on the photodetector 29.

When using an HOE separately from a beam splitter, the cost of manufacturing an optical pickup apparatus increases. In addition, since the structure of such an optical pickup apparatus is complicated, it is difficult to manufacture. Moreover, in the case where the inside of the optical pickup apparatus is heated to a high temperature during operation, positions where individual parts bond to each other may change due to melting of glue, resulting in optical aberration of light incident on a photodetector.

### SUMMARY OF THE INVENTION

Accordingly, it is an object of the present invention to provide an optical pickup apparatus having a simple structure to compensate for a deviation between optical axes.

It is another object of the present invention to provide a method of compensating for a deviation between optical axes, thereby improving the performance of an optical pickup apparatus.

Additional objects and advantages of the invention will be set forth in part in the description which follows and, in part, will be obvious from the description, or may be learned by practice of the invention.

The foregoing and other objects of the present invention are achieved by providing an optical pickup apparatus comprising: a first light source to generate a first light beam; a second light source to generate a second light beam whose optical axis is parallel to the optical axis of the first light beam, the second light source being disposed optically farther from a recording medium than the first light source; a photodetector to receive the first light beam and the second light beam which are emitted from the first and second light sources, respectively, and which are reflected from the recording medium and performing photoelectric conversion; an objective lens to focus the first light beam and second light beam on the recording medium, the objective lens being disposed on an optical path between the first and second light sources and the recording medium; and a beam splitter disposed on an optical path between the objective lens and the photodetector, the beam splitter having a first surface to reflect the first light beam and the second light beam toward the objective lens and simultaneously transmit the first light beam and the second light beam, and a second surface on which a hologram is formed to compensate for a deviation between optical axes of the first and second light beams transmitted through the first surface.

An embodiment of the present invention provides that the hologram is formed to diffract the first light beam into a relatively more +1-order diffracted light beam and relatively less residual light, and diffracting the second light beam into a relatively more zero-order diffracted light beam and relatively less residual light.

An embodiment of the present invention further provides that the first light beam and the second light beam are incident on the first surface at an angle of 45°. Approximately 50% of the first light beam is reflected and approximately 50% thereof is transmitted at the first surface.

An embodiment of the present invention further provides that the hologram diffracts the first and second light beams such that the quantity of each of the +1-order diffracted light beam of the first light beam and the zero-order diffracted light beam of the second light beam is at least 70%.

In this embodiment, a collimating lens is further provided between the objective lens and the beam splitter, and a concave lens is further provided between the beam splitter and the photodetector.

Each of the first light beam and the second light beam can be a reproduction light beam used with a digital versatile disc (DVD) or a compact disc (CD). An embodiment of the present invention provides that the first light beam is used as a reproduction light beam for DVDs when DVDs are mainly used and the second light beam is used as a reproduction light beam for CDs when CDs are mainly used.

The foregoing and other objects of the present invention may also be achieved by providing a method of compensating for a deviation between optical axes of light sources. The method comprises applying a voltage to one of the light sources to cause a light beam to be emitted; allowing the emitted light beam to be reflected from a first surface of a beam splitter, transmitted through an objective lens, focused on a recording medium, and reflected from the recording medium; allowing the light reflected from the recording medium to be incident on a second surface of the beam splitter; diffracting the light beam which is incident on the second surface of the beam splitter into a relatively more +1-order diffracted light beam and relatively less residual light when the light source emitting the light beam is optically closer to the recording medium than the other light source, and diffracting the light beam which is incident on the second surface of the beam splitter into a relatively more zero-order diffracted light beam and relatively less residual light when the light source emitting the light beam is optically farther from the recording medium than the other light source; and focusing the zero-order diffracted light beam or the +1-order diffracted light beam transmitted through the second surface on a photodetector.

An embodiment of the present invention provides that during the applying a voltage to one of the light sources, the light beam emitted from the light source is incident on the first surface of the beam splitter at an angle of 45°. Preferably, during the allowing of the emitted light beam to be reflected from the first surface of a beam splitter, 50% of the light beam is substantially reflected from the first surface of the beam splitter.

During the diffracting of the light beam incident on the second surface of the beam splitter, each of the zero-order diffracted light beam is at least 70% as much as the second light beam, and the +1-order diffracted light beam is at least 70% as much as the first light beam.

The light beam emitted from the light source optically closer to the recording medium with respect to the other light beam can be a reproduction light beam used with DVDs or a reproduction light beam used with CDs.

In a light receiving system including a beam splitter and a photodetector, the deviation between the optical axes of light beams received at the photodetector affects the reliability of an electrical signal into which an optical signal is transformed. The present invention uses a hologram to correct an optical axis in the light receiving system. However, unlike a conventional optical pickup device additionally using a separate holographic optical element, the present invention forms the hologram on a surface of the beam splitter. Accordingly, the present invention simplifies the structure of an optical pickup apparatus compared to the conventional one, thereby increasing the entire reliability of the optical pickup apparatus.

### BRIEF DESCRIPTION OF THE DRAWINGS

These and other objects and advantages of the present invention will become apparent and more readily appreciated from the following description of the embodiments, taken in conjunction with the accompanying drawings of which:

FIG. 1 is a schematic diagram of a conventional optical pickup apparatus;

FIG. 2 is an optical pickup apparatus according to an embodiment of the present invention; and

FIG. 3 is an enlarged view of the part A of FIG. 2 and illustrates a method of compensating for a difference between optical axes according to an embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below in order to explain the present invention by referring to the figures.

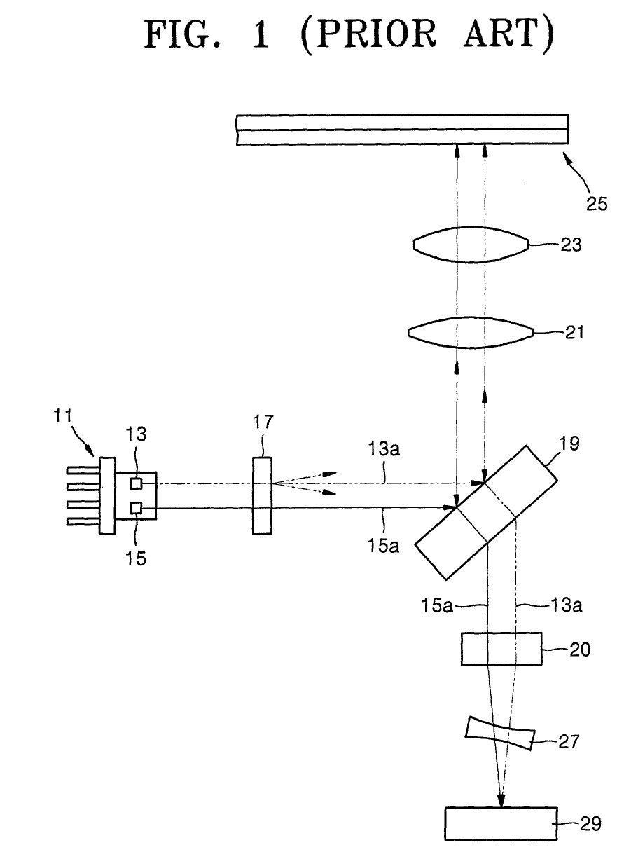

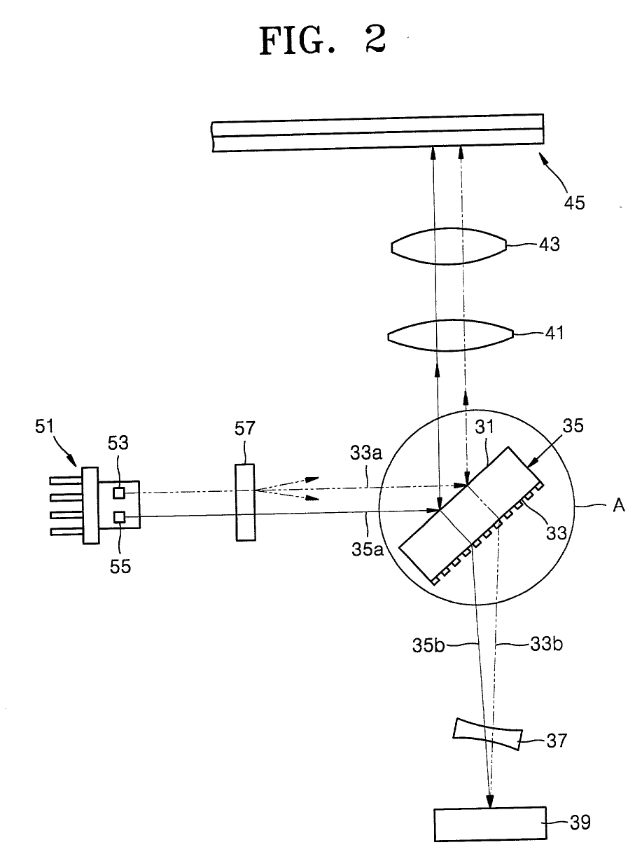

FIG. 2 is an optical pickup apparatus according to an embodiment of the present invention in which a beam splitter of the conventional optical pickup apparatus of FIG. 1 is improved. Referring to FIG. 2, the optical pickup apparatus according to an embodiment of the present invention includes a beam splitter 35 having a surface 33 on which a hologram is formed, on an optical path between an objective lens 41 and a photodetector 39.

A light source 51 is a dual wavelength laser diode and includes a first light source 53 and a second light source 55 which are adjacent and are separated by a predetermined distance of 110 μm. The first light source 53 is optically closer to a recording medium 45 than the second light source 55. The first light source 53 emits a first light beam ( to reproduce data from a compact disc (CD)) 33a. The second light source 55 emits a second light beam (to reproduce data from a digital versatile disc (DVD)) 35a whose optical axis is parallel to the optical axis of the first light beam 33a.

A grating 57 used with a CD is further provided on an optical path between the light source 51 and the beam splitter 35. The grating 57 splits the first light beam 33a into three beams. The three light beams are necessary for the photodetector 39, which performs photoelectric conversion on light reflected from a CD, to detect a tracking error signal.

The beam splitter 35 has a first surface 31 which reflects the first light beam 33a and the second light beam 35a toward the objective lens 43 and simultaneously transmits the first light beam 33a and the second light beam 35a, and a second surface 33 on which a hologram is formed. The hologram diffracts the first light beam 33a into a relatively more +1-order diffracted light beam 33b and relatively less residual light, and diffracts the second light beam 35a into a relatively more zero-order diffracted light beam 35b and relatively less residual light.

A coating is formed on the first surface 31 so that approximately 50% of each of the first light beam 33a and the second light beam 35a is reflected and approximately 50% thereof is transmitted. The hologram is manufactured so that it can diffract the first light beam 33a and the second light beam 35a such that the quantities of the +1-order diffracted light beam 33b and the zero-order diffracted light beam 35b are at least 70% of the quantities of the first light beam 33a and the second light beam 35a, respectively, by adjusting the depth and space of the pattern of the hologram.

A collimating lens 41 and the objective lens 43 are sequentially arranged on an optical path between the beam splitter 35 and the recording medium 45.

Some of the first light beam 33a and the second light beam 35a is reflected from the first surface 31 of the beam splitter 35, transmitted through the collimating lens 41 and the objective lens 43, and focused on the recording medium 45. The first light beam 33a and the second light beam 35a reflected from the recording medium 45 travel back through the objective lens 43 and the collimating lens 41 and are incident on the beam splitter 35 again. Here, the zero-order diffracted light 35b of the second light beam 35a is refracted by the hologram formed on the second surface 33 according to Snell's law (i.e., with respect to the normal of the refraction surface) and travels toward the photodetector 39, and the +1-order diffracted light beam 33b of the first light beam 33a is refracted by the hologram at an angle a little larger than an angle according to Snell's law and travels toward the photodetector 39.

A concave lens 37 to compensate for coma aberration, which causes parallel light beams of the first light beam 33a and the second light beam 35a to curve toward the optical axes, is further provided on an optical path between the beam splitter 35 and the photodetector 39. The photodetector 39 receives the first light beam 33a and the second light beam 35a and performs photoelectric conversion, thereby reproducing information recorded on the recording medium 45 and detecting a focus or tracking signal error.

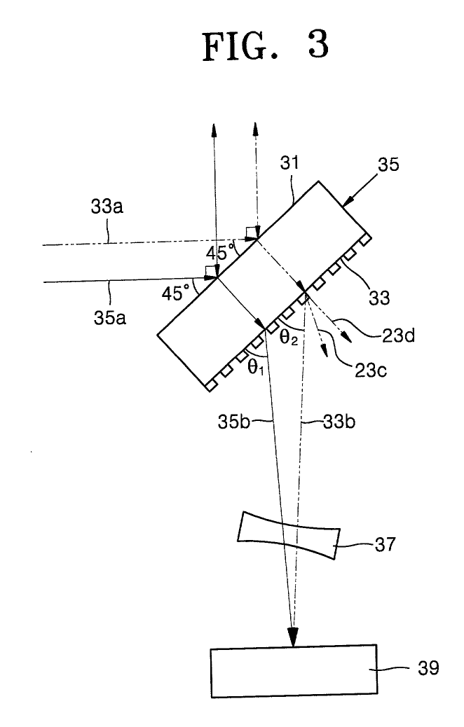

FIG. 3 is an enlarged view of the part A of FIG. 2 and illustrates a method of compensating for a deviation between optical axes according to an embodiment of the present invention. Referring to FIG. 3, the method of compensating for a deviation between optical axes according to an embodiment of the present invention comprises: applying a voltage to the light source 51 to cause the first light beam 33a or the second light beam 35a to be emitted; reflecting the emitted first or second light beam 33a or 35a on the first surface 31 of the beam splitter 35 and transmitting it through the objective lens 43 to focus it on the recording medium 45; and making the first or second light beam 33a or 35a reflected from the recording medium 45 incident on the second surface 33 of the beam splitter 35 on which a hologram is formed.

In addition, the method of compensating for a deviation between optical axes according to this embodiment of the present invention further comprises: diffracting the first light beam 33a such that the quantity of a +1-order diffracted light beam 33b of the first light beam 33a incident from the first light source 53, which is optically nearer to the recording medium 45 than the second light source 55, onto the second surface 33 is more than the quantity of the residual light beams 23c and 23d, or diffracting the second light beam 35a such that the quantity of a zero-order diffracted light beam 35b of the second light beam 35a incident from the second light source 55, which is optically farther from the recording medium 45, onto the second surface 33 is more than the quantity of the residual light beams 23c and 23d ; and focusing the zero-order diffracted light beam 35b of the second light 35a or the +1-order diffracted light beam 33b of the first light beam 33a on the photodetector 39.

As described above, the first or second light beam 33a or 35a emitted from the light source 51 and incident on the first surface 31 of the beam splitter 35 in parallel at an angle of 45 degrees, is reflected from the first surface 31 of the beam splitter 35 at an angle of 45 degrees and vertically focused on the recording medium 45. Thereafter, the first or second light 33a or 35a is reflected from the recording medium 45, travels back along the path it came, and is incident on the first surface 31 of the beam splitter 35.

The first or second light beam 33a or 35a transmitted through the first surface 31 of the beam splitter 35 is diffracted by a hologram formed on the second surface 33. As described above, the hologram is formed such that at least 70% of the first light beam 33a goes into the +1-order diffracted light beam 33b and at least 70% of the second light beam 35a goes into the zero-order diffracted light beam 35b. Accordingly, as shown in FIG. 3, the zero-order diffracted light beam 35b of the second light beam 35a and the +1-order diffracted light beam 33b of the first light beam 33a are refracted at angles of θ₁ and θ₂, respectively, according to Snell's law and travel toward the photodetector 39. It can be inferred from Equation (1) that the angle θ₁ of refraction for the second light 35a is 45°. Since the zero-order diffracted light beam 23c of the first light beam 33a is refracted at an angle of 45°, θ₂ can be a predetermined angle less than 45°.

sin 45°=n×sin 90°=sin(90°−θ₁) (1)

where “n” is the index or refraction of the beam splitter.

The zero-order diffracted light beam 23c of the first light beam 33a is refracted at the same angle of 45° as the zero-order diffracted light beam 35b of the second light beam 35a and travels in parallel to the zero-order diffracted light beam 35b of the second light beam 35a, so the difference between optical axes cannot be compensated for. In addition, the −1-order diffracted light beam 23d of the first light beam 33a travels in a different direction to the +1-order diffracted light beam 33b, with respect to the zero-order diffracted light beam 23c, so the difference between optical axes cannot be compensated for. Accordingly, the difference between optical axes can be compensated for using the zero-order diffracted light beam 35b of the second light beam 35a and +1-order diffracted light beam 33b of the first light beam 33a.

According to a method of compensating for a difference between optical axes using an optical pickup apparatus according to the present invention, since a reflection coating and a hologram are formed on a beam splitter, both optical path conversion and optical axis correction can be achieved by only a single beam splitter. In addition, since a separate holographic optical element is not necessary, the number of parts decreases, thereby simplifying the structure of an optical pickup apparatus and increasing reliability during operation at high temperature.

As described above, in an optical pickup apparatus and a method of compensating for the difference between optical axes using the same according to the present invention, a beam splitter having both a reflection coating and a hologram is used, so the structure of the optical pickup apparatus is simplified. Accordingly, the optical pickup apparatus can be easily manufactured. In addition, even if the inside of the optical pickup apparatus increases to a high temperature during operation, since the number of contact points at which optical elements bond to each other decreases, the entire performance of the optical pickup apparatus can be improved.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. An optical pickup apparatus comprising:
a first light source to generate a first light beam;
a second light source to generate a second light beam whose optical axis is parallel to the optical axis of the first light beam, the second light source being disposed optically farther from a recording medium than the first light source;
a photodetector to receive the first light beam and the second light beam which are emitted from the first and second light sources, respectively, and which are reflected from the recording medium and performing photoelectric conversion;
an objective lens to focus the first light beam and second light beam on the recording medium, the objective lens being disposed on an optical path between the first and second light sources and the recording medium; and
a beam splitter disposed on an optical path between the objective lens and the photodetector, the beam splitter having a first surface to reflect the first light beam and the second light beam toward the objective lens and simultaneously transmitting the first light beam and the second light beam, and a second surface on which a hologram is formed to compensate for a deviation between optical axes of the first and second light beams transmitted through the first surface.

2. The optical pickup apparatus according to claim 1, wherein the hologram is formed to diffract the first light beam into a relatively more +1-order diffracted light beam and relatively less residual light, and diffracting the second light beam into a relatively more zero-order diffracted light beam and relatively less residual light.

3. The optical pickup apparatus according to claim 2, wherein the first surface is set such that the first light beam and the second light beam are incident thereon at an angle of 45°.

4. The optical pickup apparatus according to claim 3, further comprising a coating formed on the first surface so that approximately 50% of the first light beam is reflected and approximately 50% thereof is transmitted.

5. The optical pickup apparatus according to claim 3, wherein the coating is formed on the first surface so that approximately 50% of the second light beam is reflected and approximately 50% thereof is transmitted.

6. The optical pickup apparatus according to claim 3, wherein the hologram is formed such that the +1-order diffracted light beam is at least 70% as much as the first light beam.

7. The optical pickup apparatus according to claim 3, wherein the hologram is formed such that the zero-order diffracted light beam is at least 70% as much as the second light beam.

8. The optical pickup apparatus according to claim 1, further comprising a collimating lens on an optical path between the beam splitter and the objective lens.

9. The optical pickup apparatus according to claim 1, further comprising a concave lens on an optical path between the beam splitter and the photodetector.

10. A method of compensating for a deviation between optical axes of light sources, the method comprising:
applying a voltage to one of the light sources to cause a light beam to be emitted;
allowing the emitted light beam to be reflected from a first surface of a beam splitter, transmitted through an objective lens, focused on a recording medium, and reflected from the recording medium;
allowing the light beam reflected from the recording medium to be incident on a second surface of the beam splitter;
diffracting the light beam which is incident on the second surface of the beam splitter into a relatively more +1-order diffracted light beam and relatively less residual light when the light source emitting the light beam is optically closer to the recording medium than the other light source, and diffracting the light beam which is incident on the second surface of the beam splitter into a relatively more zero-order diffracted light beam and relatively less residual light when the light source emitting the light beam is optically farther from the recording medium than the other light source; and
focusing the zero-order diffracted light beam or the +1-order diffracted light beam transmitted through the second surface on a photodetector.

11. The method according to claim 10, wherein in the second operation, the light beam emitted from the light source is incident on the first surface of the beam splitter at an angle of 45°.

12. The method according to claim 10, wherein in the second, 50% of the light beam is substantially reflected from the first surface of the beam splitter.

13. The method according to claim 10, wherein in the fourth operation, the zero-order diffracted light beam is at least 70% as much as the second light beam.

14. The method according to claim 10, wherein in the fourth operation, the +1-order diffracted light beam is at least 70% as much as the first light beam.

15. An optical pickup apparatus comprising:
a first light source to generate a first light beam;
a second light source to generate a second light beam whose optical axis is parallel to the optical axis of the first light beam, the second light source being disposed optically farther from a recording medium than the first light source;
a photodetector to receive the first light beam and the second light beam which are emitted from the first and second light sources, respectively, and which are reflected from the recording medium and performing photoelectric conversion;
an objective lens to focus the first light beam and second light beam on the recording medium, the objective lens being disposed on an optical path between the first and second light sources and the recording medium; and
a beam splitter disposed on an optical path between the objective lens and the photodetector, the beam splitter having a first surface to reflect the first light beam and the second light beam toward the objective lens, and a second surface which receives the first and second light beams reflected from the recording medium, to compensate for a deviation between optical axes of the first and second light beams transmitted through the first surface.

16. The optical pickup apparatus according to claim 15, wherein the second surface comprises a hologram.

17. The optical pickup apparatus according to claim 15, further comprising a coating formed on the first surface so that a portion of the first and second light beams is reflected and the remaining portion of the first and second light beams is transmitted.
